(19) United States
(12) Patent Application Publication
(10) Pub. No.: US 2010/0326751 A1
(43) Pub. Date: Dec. 30, 2010

(54) HYBRID DRIVE APPARATUS

(76) Inventor: Johann Märkl, Ingolstadt (DE)

Correspondence Address: Novak Druce & Quigg LLP, 300 New Jersey Ave, NW, Fifth Floor, Washington, DC, 20001, US

(21) Appl. No.: 12/439,550

(22) PCT Filed: Aug. 29, 2007
(86) PCT No.: PCT/EP2007/007523

§ 371 Date: Jun. 30, 2009

(30) Foreign Application Priority Data
Sep. 1, 2006 (DE) 10 2006 041 159.5

(51) Int. Cl. B60K 6/46

(52) U.S. Cl. 180/65.245; 180/65.21

(57) ABSTRACT

The invention relates to a hybrid drive apparatus for motor vehicles, having an internal combustion engine and an electric drive motor which act connected in series on at least one driven shaft which drives an axle differential. To achieve a drive apparatus which is favorable in efficiency and installation size, it is proposed that in addition, by means of transmission stages, there is at least one constant gear which, bypassing the electric drive motor, selectively drives the driven shaft from the internal combustion engine.

The invention relates to a hybrid drive apparatus for motor vehicles.

### BACKGROUND OF THE INVENTION

Such a hybrid drive apparatus is described, for example, by EP 1 092 583 A1 in which the electrical drive motor is made as an electromagnetic converter by means of which, among other things, the transmission ratio to the driven shaft of the drive apparatus can be controlled in a specified spread. The transmission ratio can be changed by way of a transmission stage which is connected downstream from the electric drive motor, for example, in the form of a planetary gear train and a clutch, however, the power flow always running by way of the electric drive motor.

The object of the invention is to propose a hybrid drive apparatus of the generic type which, in addition to a design which is favorable in terms of construction and production engineering, enables an improvement in efficiency or a compact design.

### SUMMARY OF THE INVENTION

According to the invention, it is proposed that in addition, by means of transmission stages, there is at least one constant gear which, bypassing the electric drive motor, selectively drives the driven shaft from the internal combustion engine. The invention is designed to bypass the electric drive motor in certain driving ranges of the motor vehicle and to directly drive the axle differential or differentials from the internal combustion engine at favorable efficiency (for all-wheel drive). This also results in a construction which is simpler in design and spatial dimensioning of the electric drive motor because a defined driving range of the motor vehicle need not be covered by way of the spread of the electrical converter. The invention is suited both for longitudinal and transverse installation and also for mid-engine motor vehicles. Specifically, longitudinal installation is assumed below. But what is stated also applies analogously to transverse installation.

The constant gear can be preferably a starting gear and/or a fast speed gear which can be activated by way of at least one shifting device. In a fully automatic version of the hybrid drive apparatus the shifting device can be an electro-hydraulically controlled multi-disk clutch; the shifting device, however, can also be a synchronous clutch which is conventional in speed-change transmissions, or another positive clutch.

In a design of the hybrid drive apparatus which is favorable for installation space, the internal combustion engine and the electric motor can drive a drive shaft which is connected propulsively to the driven shaft by way of a secondary shaft and a set of gears, the drive shaft and the secondary shaft bearing gear sets as the transmission stage for at least one constant gear, and the shifting device. As is known in gear sets, an especially favorable efficiency of the gear train is achieved here which is especially advantageous in the layout of the constant gear as a fast speed gear or economy gear.

In this connection, the gear sets can be located downstream on the drive shaft and the secondary shaft of the electric drive motor.

Alternatively, the drive shaft of the internal combustion engine and the drive shaft of the electric motor can be arranged axially offset to one another by means of a spur gear set in order to better take into account mechanical constraints in the arrangement of the drive assembly which is composed of the internal combustion engine, electric drive motor, and optionally an integrated axle differential in the motor vehicle.

For this purpose the gear sets for at least one constant gear and the clutch can furthermore be located on the drive shaft of the electric drive motor and the driven shaft and three-dimensionally between the internal combustion engine and the electric drive motor, as a result of which the indicated spur gear set and the gear set of the constant gear transmission stage can be located directly adjacent to one another.

Moreover, the drive shaft of the electric drive motor can be especially advantageously positioned to the bottom or top and/or laterally offset relative to the drive shaft of the internal combustion engine. Thus, it is possible to design the rotors and at least one stator of the electric drive motor for a high drive and transmission output and nevertheless to ensure sufficient installation space in the body of the motor vehicle.

The electric drive motor can be implemented conventionally by two independent electric motors with two rotors and two stators or a common stator or by an electromagnetic gear train with two rotors and at least one jointly axially movable stator.

Finally, for longitudinal installation of the internal combustion engine and electric drive motor and the axle differential located in between for a front-wheel drive of the motor vehicle, the driven shaft can act directly or indirectly on the axle differential for driving the front wheels of the motor vehicle.

### BRIEF DESCRIPTION OF THE DRAWINGS

FIG. 1 shows a top view of a hybrid drive apparatus for a front-wheel drive vehicle with an internal combustion engine, an electric drive motor, an integrated axle differential, and a transmission stage which is connected downstream from the electric drive motor; and

FIG. 2 shows a side view of an alternative hybrid drive apparatus, with an electric drive motor which is axially offset to the internal combustion engine, and a transmission stage which is connected upstream from the electric drive motor.

### DETAILED DESCRIPTION OF THE PREFERRED EMBODIMENTS OF THE INVENTION

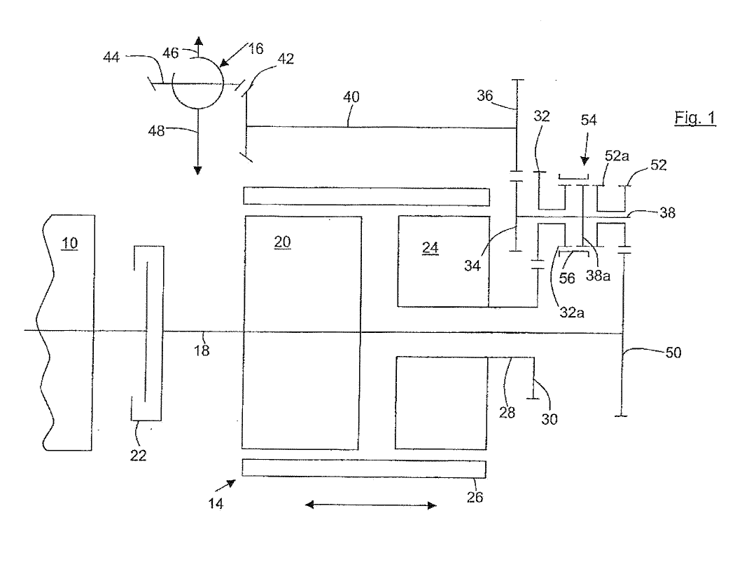

As shown in FIG. 1, the hybrid drive apparatus is composed essentially of an internal combustion engine 10 which is only suggested, an electric drive motor 14, and an axial differential 16 located in between for driving the front wheels (not shown) of the motor vehicle. The components can be located conventionally in several housings and can be assembled into a drive assembly.

The internal combustion engine 10, in particular a reciprocating internal combustion engine, is connected to the first rotor 20 of the drive motor 14 by way of a power output shaft and a drive shaft 18, optionally a friction clutch being connected in between with optionally a torsional vibration damper.

The second rotor 24 of the drive motor 14 is pivoted on the drive shaft 18 and bears a drive shaft 28 which is made as a hollow shaft. Around the two rotors 20, 24 there is an axially movable stator 26a, by means of which for corresponding electrical actuation (not shown) the electric drive motor 14 can be operated conventionally as a converter with a defined spread of the transmission ratio. Optionally the stator, as can be taken from the top half of the figure, can also be made as a stator 26b which is common to both rotors.

The drive shaft 28 of the rotor 24 drives a driven shaft 40 which is located laterally to the stator 26 by way of downstream gear sets 30, 32, 34, 36 and by way of a secondary shaft 38. The driven shaft 40 which runs forward of the internal combustion engine 10 furthermore bears a driving pinion 42 which meshes with the crown gear 44 of the axle differential 16 which is made conventionally as a bevel gear differential.

In turn the axle differential 16 drives the front wheels of the motor vehicle conventionally by way of the axle half-shafts 46, 48 which run transversely to the drive shaft 18 and which are only suggested, and by way of cardan shafts which are not shown.

The drive shaft 18 which extends through the rotor 24 of the electric drive motor 14 on its free end bears a gear 50 which is propulsively connected to another gear 52 on the secondary shaft 38.

The two gears 32, 52 which are adjacent to one another on the secondary shaft 38 are loose gears which can be coupled selectively to the secondary shaft 38 by way of a clutch 54. The clutch 54 can be a claw clutch or a synchronous clutch of conventional design, with shifting tooth systems 32a, 52a which are molded onto the gears 32, 52, an externally toothed clutch body 38a which is fixed on the secondary shaft 38, and an axially movable, internally toothed shift collar 56.

By means of the shift collar 56, whose actuation in the conventional manner can take place manually or automatically, in addition to optionally an idle position either the drive shaft 28 by way of the gear set 30, 32 or the drive shaft 18 by way of the gear set 50, 52 can be propulsively coupled to the secondary shaft 38, while the secondary shaft 38 is always propulsively connected to the driven shaft 40 by way of the gear set 34, 36.

The gear sets 30, 32 and 34, 36 are designed in their overall transmission such that a defined driving range of the motor vehicle is covered with a spread which can be controlled by the electric drive motor 14. Power flow takes place conventionally by way of the internal combustion engine 10, the drive shaft 18, the rotor 20, and by way of the electrically actuated stator 26, the rotor 24 of the electric drive motor 14 to the drive shaft 28, and from there by way of the indicated gear sets 30, 32, 34, 36 to the driven shaft 40 or the axle differential 16.

If the gear 52 is coupled to the secondary shaft 38 by way of the clutch 54, at this point the internal combustion engine 10 by way of the drive shaft 18 directly or, bypassing the electric drive motor 14, by way of the gear sets 50, 52, 34, 36 drives the driven shaft 40, etc. The gear set 50, 52 which is connected to the power flow thus forms a constant gear or constant transmission ratio which is designed such that its transmission ratio borders the variable transmission which is formed by the converter region of the electric drive motor 14.

The constant gear can be laid out by designing the gears 50, 52 in conjunction with the remaining fixed transmission ratio by the gear 34, 36 and the axle differential 16 as a starting gear with very short transmission or as a fast speed gear or economy gear with very long transmission so that the total transmission spread is larger than the spread of the converter range of the electric drive motor 14.

The described hybrid drive apparatus is designed for front-side, longitudinal installation in a motor vehicle. When using a modified axle differential 16 (driving pinion 42 and crown gear 44 not as bevel gears, but as spur gears, axle half-shafts 46, 48 aligned parallel to the drive shaft 18) the hybrid drive apparatus can also be used in a transverse installation.

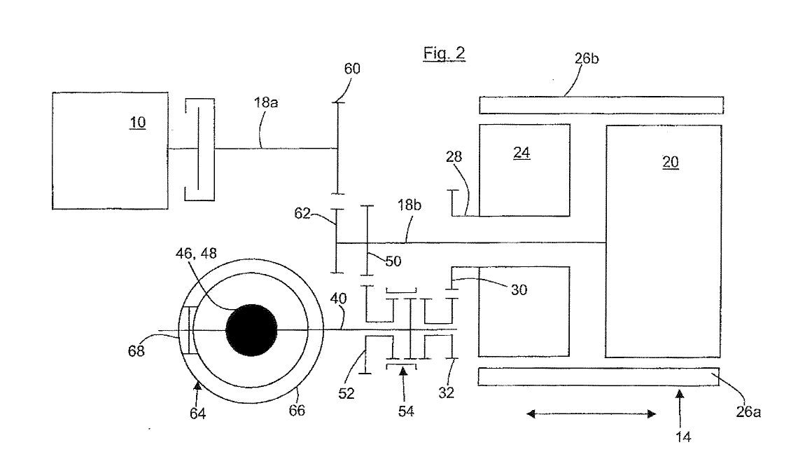

An alternative hybrid drive apparatus is shown in FIG. 2. Functionally identical parts are provided with the same reference numbers. The description for FIG. 1 applies to the same functions.

As shown in FIG. 2, the drive shaft 18 is divided into a drive shaft segment 18a and a drive shaft segment 18b which are positioned axially offset to one another with the interposition of a spur gear set 60, 62. The offset of the drive shaft segment 18b is both down and to the side, from which with respect to the arrangement of the electric drive motor 14 and of the axle differential 64 the mechanical degrees of freedom are larger and the given installation conditions in the motor vehicle can be increasingly taken into account. FIG. 2 does not show the entire offset, for the sake of clarity.

The additional constant gear formed by the gears 50, 52 and the clutch 54 is connected upstream from the electric drive motor 14 or is located between the internal combustion engine 10 and the electric drive motor 14. Furthermore, the rotor 24 by way of the drive shaft 28 forward by way of the gears 30, 32 drives the driven shaft 40 which is not located laterally, but in front of the electric drive motor 14.

As is apparent, in this design the secondary shaft 38 as shown in FIG. 1 is omitted and the clutch 54 and the movable gears of the gear sets 30, 32, 50, 52 are located directly on the driven shaft 40. The gears 50, 52 here in turn form the constant gear as described above.

The invention is not limited to the described embodiments. Thus, instead of the positive clutch 54, a hydraulically controlled multi-disk clutch can also be used. For a positive clutch 54 optionally the synchronization of the rotational speed of the shaft prior to the shifting process can take place by corresponding actuation of the electric drive motor 14 when the friction clutch has been released to the internal combustion engine 10.

Instead of a constant gear as described above, two constant gears (starting gear and fast speed gear) can also be provided by the corresponding arrangement of another gear set. The constant gears can optionally also be implemented by means of a planetary gear train.

Moreover, the individual position data for FIGS. 1 and 2 each relate to the illustration specifically shown there.

1. A hybrid drive apparatus for motor vehicles, having an internal combustion engine and an electric drive motor which act connected in series on at least one driven shaft which drives an axle differential wherein in addition, by means of transmission stages, there is at least one constant gear which, bypassing the electric drive motor, selectively drives the driven shaft from the internal combustion engine.

2. The hybrid drive apparatus according to claim 1, wherein the constant gear is a starting gear which can be activated by way of a shifting device.

3. The hybrid drive apparatus according to claim 1, wherein the constant gear is a fast speed gear which can be activated by way of a shifting device.

4. The hybrid drive apparatus according to claim 1 wherein the internal combustion engine and the electric drive motor drive a drive shaft which is connected drivingly to the driven shaft by way of a secondary shaft and a set of gears, the drive shaft, and the secondary shaft bearing gear sets as the transmission stage for at least one constant gear, and the shifting device.

5. The hybrid drive apparatus according to claim 1, wherein the gear sets are located downstream on the drive shaft and the secondary shaft of the electric drive motor.

6. The hybrid drive apparatus according to claim 1 wherein the drive shaft of the internal combustion engine and the drive shaft of the electric drive motor are arranged axially offset to one another by means of a spur gear set.

7. The hybrid drive apparatus according to claim 6, wherein the gear of the electric drive motor and the driven shaft and three-dimensionally between the internal combustion engine and the electric drive motor.

8. The hybrid drive apparatus according to claim 6 wherein the drive shaft of the electric drive motor is positioned to the bottom or top and/or laterally offset relative to the drive shaft of the internal combustion engine.

9. The hybrid drive apparatus according to claim 1 wherein for longitudinal installation of the internal combustion engine and the electric drive motor and the axle differential located in between, for a front-wheel drive of the motor vehicle the driven shaft acts directly or indirectly on the axle differential for driving the front wheels of the motor vehicle.

10. The hybrid drive apparatus according to claim 1 wherein the electric drive motor is implemented by two independent electric motors with two rotors and two stators.

11. The hybrid drive apparatus according to claim 1 wherein the electric drive motor is formed by an electromagnetic gear train with two rotors and at least one common, optionally axially movable stator.

12. The hybrid drive apparatus according to claim 1 wherein the apparatus is made for longitudinal and transverse installation or a mid-engine structure.

13. A hybrid drive assembly for a motor vehicle, comprising:
an internal combustion engine provided with an output shaft;
an electric drive motor vehicle provided with a first rotor mounted on said engine output shaft and a second rotor having an output shaft disposed coaxially with said engine output shaft;
a front wheel differential having an input shaft disposed laterally and parallel to said engine output shaft;
a clutch provided with an output shaft disposed laterally of the axis of said engine output shaft;
a first gear set drivingly interconnecting said engine output shaft and said clutch;
a second gear set drivingly interconnecting said rotor output shaft and said clutch; and
means drivingly interconnecting said clutch output shaft and said differential output shaft.

14. A hybrid drive according to claim 13 wherein said means drivingly interconnecting said clutch output shaft and said differential input shaft comprises a third gear set.

15. A hybrid drive assembly for a motor vehicle, comprising:
an internal combustion engine provided with an output shaft;
an electric motor provided with a first rotor having an output shaft displaced laterally of said engine out shaft, and a second rotor having an output shaft coaxially with said first rotor output shaft;
a front wheel differential having an output shaft disposed laterally of first rotor output shaft and forwardly of said electric motor;
a clutch provided with an output shaft operating connected to said differential, disposed between said electric motor and said differential;
means drivingly interconnecting said first rotor output shaft and said clutch; and
means drivingly interconnecting said second rotor output shaft and said clutch.

16. A hybrid device assembly according to claim 15 wherein each of said drivingly interconnecting means comprises a gear set.

17. A hybrid drive assembly according to claim 15 wherein said output shaft of said clutch is disposed laterally and below a centerline of said vehicle.

18. A hybrid drive assembly according to claim 13 wherein said components are positioned in a compacted relationship permitting said assembly to be inserted into a compartment of said vehicle in one of a longitudinal and transverse direction.
